(19) United States
(12) Patent Application Publication
(10) Pub. No.: US 2026/0154514 A1
(43) Pub. Date: Jun. 4, 2026

(54) LANGUAGE MODEL PERFORMANCE ON LOW RESOURCE LANGUAGES

(71) Applicant: NVIDIA Corporation, Santa Clara, CA (US)

(72) Inventors: Raviraj JOSHI, Maharashtra (IN); Kanishk SINGLA, Pune (IN); Anusha KAMATH, Bengaluru (IN); Raunak KALANI, Bengaluru (IN); Utkarsh VAIDYA, Pune (IN); Sanjay Singh CHAUHAN, Pune (IN); Niranjan WARTIKAR, Pune (IN); Eileen Margaret Peters LONG, San Jose, CA (US)

(21) Appl. No.: 19/346,369

(22) Filed: Sep. 30, 2025

(30) Foreign Application Priority Data
Oct. 19, 2024 (IN) 202441079541

(51) Int. Cl. G06F 40/58

(52) U.S. Cl. CPC G06F 40/58

(57) ABSTRACT

In various examples, techniques are described for adapting a multilingual Large Language Model (LLM) into a bilingual Small Language Model (SLM) that exhibits model capacity to understand, process, and generate content in both English and a Low-Resource Language (LRL). The techniques include compressing the LLM to generate a multilingual SLM and performing continued pre-training on the multilingual SLM to generate the bilingual SLM. The techniques also include performing one or more alignment techniques on the bilingual SLM to adapt the SLM's outputs to human values and expectations regarding, e.g., profanity, privacy, politeness, bias, and/or conversational style. The techniques may generate various training corpora, each including one or more of natural English content, natural LRL content, synthetic LRL content generated via translation from English sources, and transliterated synthetic LRL content based on transliterations of natural and/or synthetic LRL content.

### CROSS REFERENCE TO RELATED APPLICATIONS

This application claims the priority of co-pending Indian patent application titled, ADAPTING MULTIMODAL LLMS TO LOW-RESOURCE LANGUAGES USING CONTINUED PRE-TRAINING AND SYNTHETIC CORPUS, filed on Oct. 19, 2024, and having Serial No. 202441079541. The subject matter of this related application is hereby incorporated herein by reference.

### TECHNICAL FIELD

Embodiments of the present disclosure relate generally to generative machine learning models, and more specifically, to adapting multilingual Large Language Models (LLMs) to low-resource languages.

### BACKGROUND

In the field of generative machine learning models, Large Language Models (LLMs) may include several billion learnable parameters, such as 8 B, 12 B, or 15 B parameters. The largest LLMs may include over one trillion (1 T) parameters. Small Language Models (SLMs) may include a few million to a few billion parameters, such as 100 M, 1 B, or 4 B parameters. While there is no definitive numerical boundary between “large” and “small” language models, there is a general trend that larger models may exhibit a greater “model capacity” to understand, process, and generate natural language content. Larger models may also require a larger training corpus of tokens and/or a longer training period to realize their potentially greater model capacity.

A multilingual LLM may be trained using on or more training corpora each including billions, hundreds of billions, or trillions of tokens. These training corpora may include tokens expressed in a variety of languages, giving the trained multilingual LLM at least a limited model capacity in multiple languages. However, there are Low-Resource Languages (LRLs) that are not sufficiently represented in typical training corpora to give a trained multilingual LLM significant model capacity in a particular LRL. When a language lacks large monolingual or parallel corpora (e.g., data source pairs that each include an LRL data source and a corresponding English translation of the LRL data source) and/or manually crafted linguistic resources sufficient for building statistical Natural Language Processing (NLP) applications, it may be considered a low-resource language.

Many training corpora are built from information gathered from the internet, where English is the predominant language. As a result, a language may be considered to be a low-resource language based on its prevalence in online sources, rather than the number of people who speak the language. For example, there are approximately 600 million Hindi speakers, representing over 7% of the world's population. Hindi representation in a typical LLM training corpus, given as a percentage of tokens in the corpus that are expressed in Hindi, may be as low as 0.25%. Of the approximately 7,000 languages spoken worldwide, all but a few dozen may be fairly described as LRLs. As discussed herein, while a trained multilingual LLM may exhibit limited model capacity in one or more LRLs, the usability of the trained multilingual LLM in an LRL may be questionable, as the multilingual LLM may hallucinate frequently, generate meaningless sentences, and/or mix English content into a reply generated in response to an LRL query. It would be advantageous to design language models that exhibit greater model capacity in low-resource languages.

Existing methods for improving the LRL capacity of a language model may include Supervised Fine-Tuning (SFT) using only LRL training tokens that have been translated into the LRL from English. One drawback of these existing methods is that while fine-tuning may enhance a model's instruction-following capability, it may not improve the model's understanding of regional contexts associated with the LRL, such as figurative or idiomatic language or region-specific information. Other existing methods may apply continued pre-training to the language model, using only training tokens expressed in the LRL. One drawback of these methods is that the limited availability of LRL tokens suitable for training purposes makes continued pre-training both infeasible and prone to causing the language model to overfit the available LRL data. Still other methods may include training a language model from scratch—e.g., using only LRL training tokens in the initial model training phase. One disadvantage of these methods is that the limited availability of LRL training tokens may restrict these methods to training relatively small language models, such as models containing significantly fewer than one billion parameters. Consequently, these smaller models may exhibit reduced post-training model capacity compared to LLMs, or compared to Small Language Models (SLMs) that include a greater number of parameters.

### SUMMARY

Embodiments of the present disclosure relate to improving language model performance on a low-resource language (LRL) using continued pretraining and a synthetic training corpus. Systems and methods are disclosed which receive a trained multilingual LLM and compress the multilingual LLM to generate a compressed base model that includes a multilingual SLM. The disclosed systems and methods also perform continued pre-training and model alignment on the multilingual SLM to generate an aligned bilingual SLM. The disclosed techniques include an adaptation engine that receives the trained multilingual LLM and compresses the multilingual LLM to generate the base model The adaptation engine receives natural English training tokens, where a “natural” English token is one that is expressed in English, rather than having been translated into English. Similarly, the adaptation engine receives natural LRL training tokens, expressed in the LRL to which the LLM is being adapted. The adaptation engine also generates synthetic LRL training data used in subsequent continued pre-training and alignment operations. The generation may include translating English tokens into synthetic LRL tokens, and/or transliterating LRL tokens (natural and/or synthetic) into synthetic LRL Roman script training tokens.

The adaptation engine performs continued pre-training operations on the multilingual base model, using a combination of natural English tokens, natural LRL tokens, and synthetic LRL tokens. While the continued pre-training does not eliminate the base model's multilingual capacity, at the conclusion of the continued pre-training the base model may be considered to be a bilingual (English and LRL) SLM, rather than a multilingual SLM. The adaptation engine performs model alignment on the bilingual SLM, including Supervised Fine-Tuning (SFT) and Direct Preference Optimization (DPO) to generate an aligned bilingual SLM that is operable to understand, process, and generate natural language content expressed in the LRL. Because the continued pre-training and the DPO employ both English and LRL tokens, the aligned bilingual SLM is also operable to understand and process content presented in a hybrid English dialect that includes both English and LRL words and/or phrases.

In contrast to conventional methods that attempt to generate LRL language models from scratch, the disclosed systems and methods may generate language models having a larger number of parameters, because the disclosed systems and methods are not constrained to using only natural LRL training tokens. Further, the disclosed systems and methods are not restricted to using only LRL tokens during supervised fine-tuning, and may improve both the model's instruction-following capacity and its understanding of regional contexts. Finally, the disclosed systems and methods are not limited to using LRL tokens during continued pre-training. Consequently, the disclosed systems and methods may generate aligned bilingual SLMs that exhibit high model capacity without overfitting to a limited amount of training data.

### BRIEF DESCRIPTION OF THE DRAWINGS

The present systems and methods for improving the performance of language models on low-resource languages are described in detail below with reference to the attached drawing figures, wherein:

FIG. 1 illustrates a computing device configured to implement one or more aspects of various embodiments;

FIG. 2 is a more detailed illustration of the adaptation engine of FIG. 1, according to various embodiments;

FIG. 3 illustrates a flow diagram of a method for generating an aligned bilingual SLM, according to various embodiments;

FIG. 4A is a block diagram of an example generative language model system suitable for use in implementing at least some embodiments of the present disclosure;

FIG. 4B is a block diagram of an example generative language model that includes a transformer encoder-decoder suitable for use in implementing at least some embodiments of the present disclosure;

FIG. 4C is a block diagram of an example generative language model that includes a decoder-only transformer architecture suitable for use in implementing at least some embodiments of the present disclosure;

FIG. 5 is a block diagram of an example computing device suitable for use in implementing at least some embodiments of the present disclosure; and

FIG. 6 is a block diagram of an example data center suitable for use in implementing at least some embodiments of the present disclosure.

### DETAILED DESCRIPTION

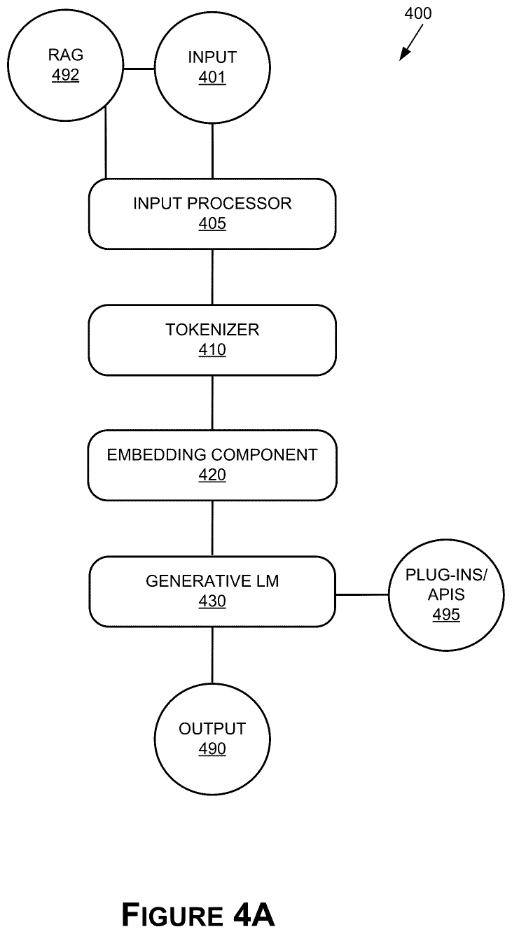

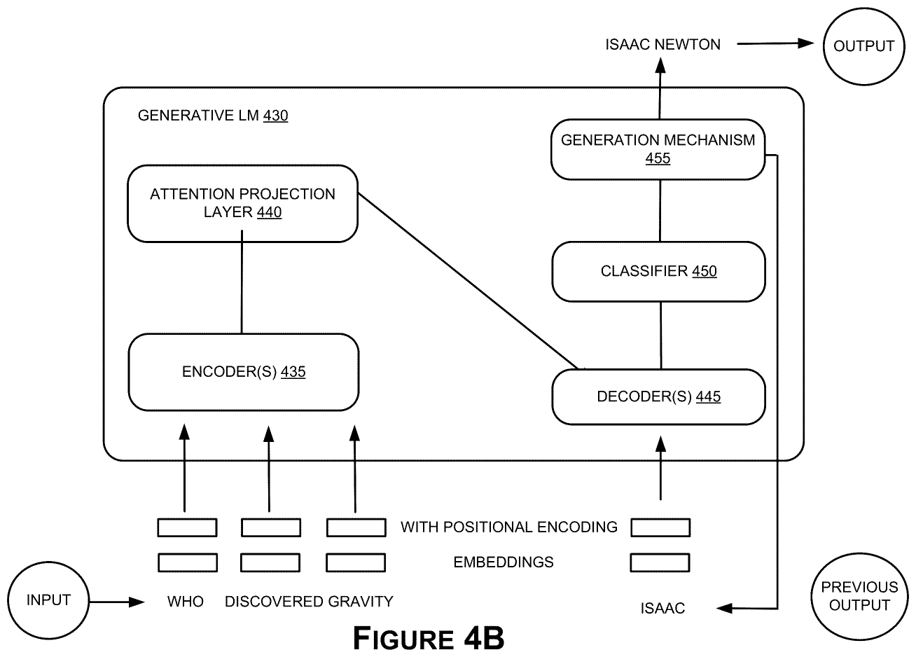

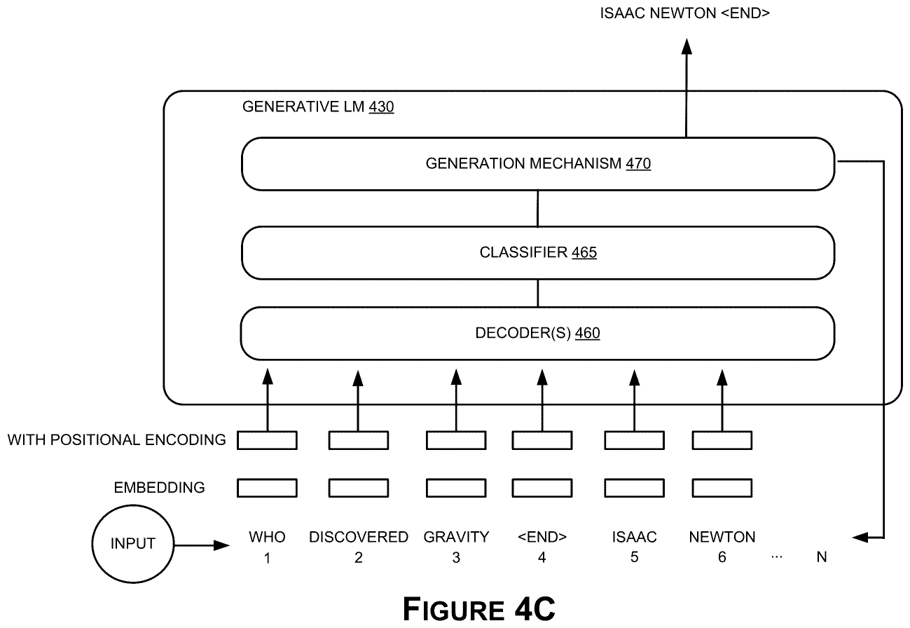

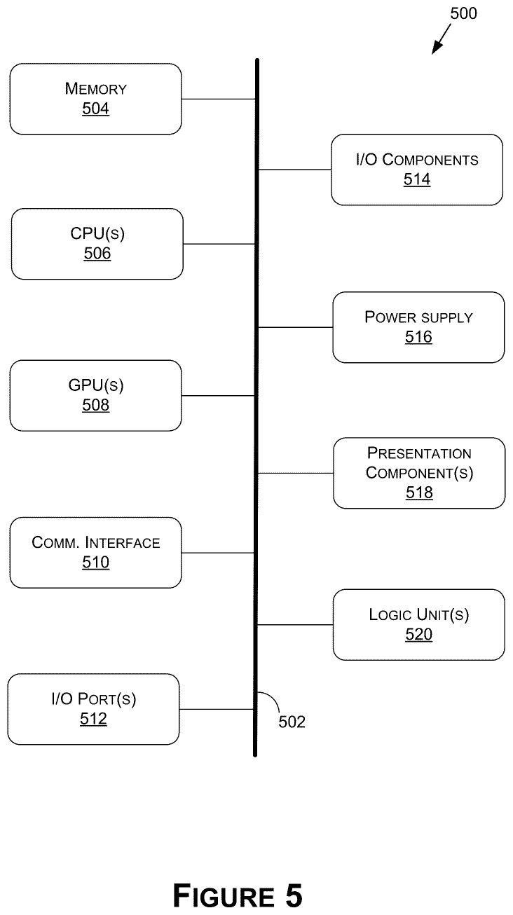

Systems and methods are disclosed related to improving the performance of language models on a low-resource language (LRL) using continued pretraining and a synthetic training corpus. Although aspects of the present disclosure may be described with respect to generative language models such as those described with respect to FIGS. 4A-4C, this is not intended to be limiting. For example, the systems and methods described herein may be used by, without limitation, generative machine learning models in which one or more dense layers, each including a single MLP, such as an FFN, may be replaced with one or more sparse layers including multiple MLPs. In some embodiments, the systems, methods, and/or processes described herein may be executed using similar components, features, and/or functionality to those of example computing device 500 of FIG. 5.

As discussed herein, conventional techniques for improving the LRL capacity of a language model may include Supervised Fine-Tuning (SFT) using only LRL training tokens that have been translated into the LRL from English. These techniques may not improve the model's understanding of regional contexts associated with the LRL, such as figurative or idiomatic language or region-specific information. Other existing methods may apply continued pre-training to the language model, using only training tokens expressed in the LRL. Because of the limited availability of natural LRL sources, e.g., native LRL training data, rather than training data translated into LRL from another language, these techniques may not be feasible for training a model including desired number of parameters, and the trained model may overfit the available LRL data. Other techniques may attempt to train a language model from scratch, using only LRL training tokens in the initial model training phase. Similar to the LRL-only continued pre-training techniques, the limited availability of LRL training tokens may restrict these methods to training relatively small language models, such as models containing significantly fewer than one billion parameters. Consequently, these smaller models may exhibit reduced post-training model capacity compared to LLMs, or compared to Small Language Models (SLMs) that include a greater number of parameters

To further improve the performance of language models on a low-resource language, the disclosed techniques may compress an existing trained multilingual LLM to generate a multilingual Small Language Model (SLM). The techniques may re-train the multilingual SLM with a small portion, e.g., less than 3%, of the multilingual training corpus used to initially train the LLM. The techniques perform continued pre-training on the multilingual SLM using a mixture of English and LRL training sources, and generates a trained bilingual (English and SLM) SLM. The techniques further apply one or more alignment techniques to the bilingual SLM using English-only training sources to produce an aligned SLM. The disclosed techniques include synthetic training data at all stages of continued pre-training and alignment. The disclosed techniques leverage continued pre-training and a training corpus including synthetic data sources to adapt a multilingual SLM into an aligned SLM that expresses greater model capacity in the low-resource language compared to the LLM, while maintaining the English model capacity. The inclusion of natural low-resource language data sources also improves the aligned SLM's model capacity in regional contexts compared to the LLM.

An adaptation engine receives a trained multilingual LLM that may include a relatively large number of parameters, such as 8 B (billion), 12 B, or 15 B parameters. While the multilingual LLM may exhibit some model capacity in a low-resource language (LRL), the model capacity is likely to be limited, as only a fraction of a percent of the LLM training data set may be expressed in the LRL. The adaptation engine compresses the multilingual LLM via one or more pruning and/or distillation techniques to generate a multilingual Small Language Model (SLM) having, e.g., 4 B parameters. The adaptation engine may re-train the multilingual SLM using a training dataset that includes a small portion, e.g., less than 3%, of the training data originally used to train the LLM. In at least one embodiment, the training dataset may include natural Low-Resource Language (LRL) data and synthetic LRL data generated by translating High-Resource Language (HRL) data to the LRL.

The adaptation engine prepares a training corpus based on available natural English sources and natural LRL sources, where a natural source is one that has not been translated or transliterated into its current language. The adaptation engine translates the natural English sources into the LRL to generate synthetic LRL sources. The adaptation engine also transliterates the natural LRL sources and the synthetic LRL sources into a Roman script to generate additional synthetic LRL sources. The inclusion of transliterated LRL content in subsequent pre-training improves the resulting model's capacity to understand and process queries that include a hybrid mixture of English and the LRL. While generating synthetic LRL sources, the adaptation engine may filter out low-quality translations using one or more of a back-translation evaluation technique or an n-gram language model.

The adaptation engine performs continued pre-training on the multilingual SLM to generate a bilingual (English and LRL) SLM. The adaptation engine may construct a continued pre-training data set including approximately 400 B tokens, divided roughly equally into English and the LRL. The LRL tokens in the continued pre-training data set may include both natural and synthetic LRL tokens in a ratio of approximately 80% synthetic to 20% natural. The output of the continued pre-training is a bilingual SLM that expresses improved LRL model capacity compared to the LLM, both in terms of instruction following and regional context.

The adaptation engine performs one or more alignment techniques on the bilingual SLM to encode human expectations and values into the SLM and to encourage SLM output that is appropriate, unbiased, and that meets human expectations for a conversational model interface. The adaptation engine may perform Supervised Fine-Tuning (SFT), using a general SFT corpus including, for example, 200 k English-only tokens. Alternatively or additionally, the adaptation engine may perform Direct Preference Optimization (DPO) using a DPO corpus that includes both natural English and synthetic translated LRL content. After alignment, the adaptation engine generates an aligned SLM that exhibits significant model capacity in both English and the LRL, as well as a capacity to understand and process hybrid queries including both English and LRL content.

### System Overview

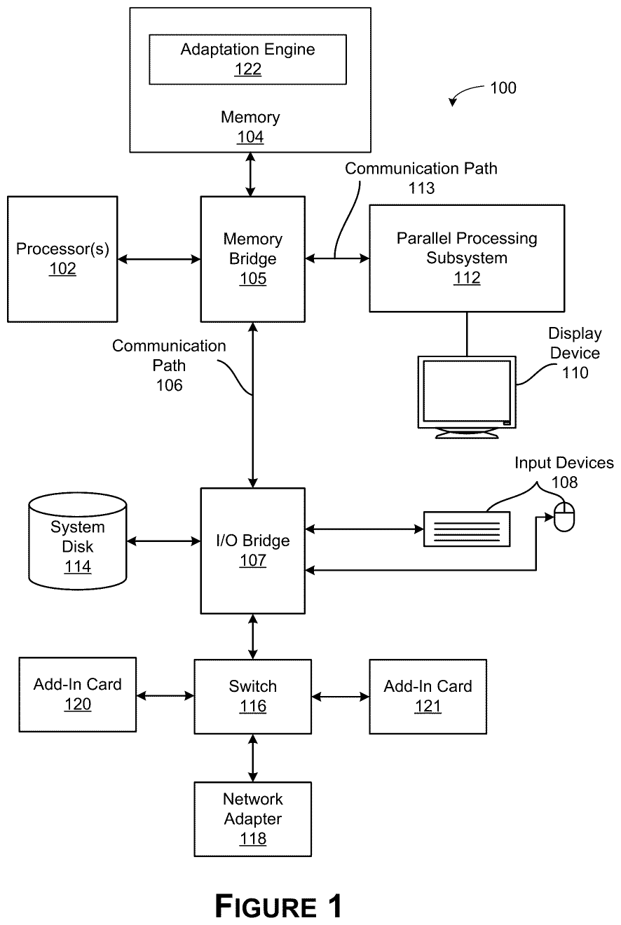

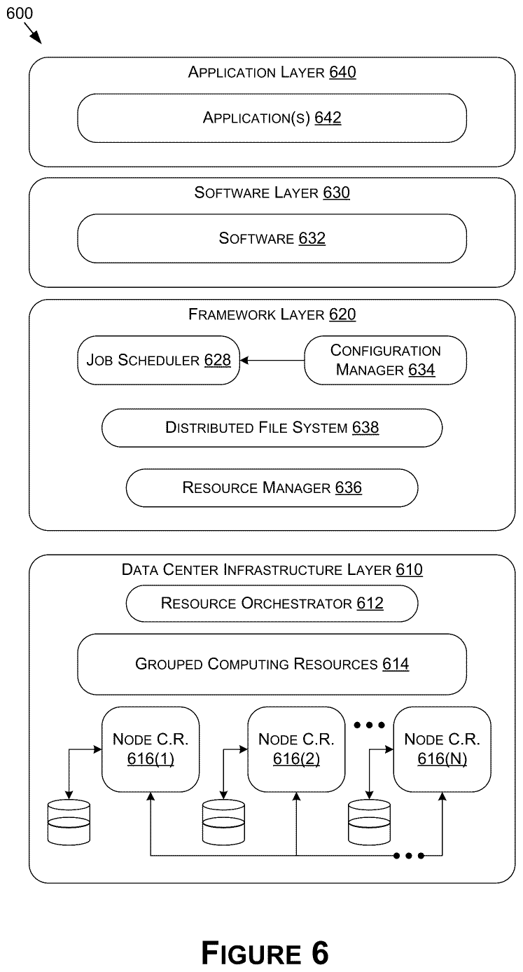

With reference to FIG. 1, FIG. 1 is a block diagram illustrating a computing system 100 configured to implement one or more aspects of at least one embodiment of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processors executing instructions stored in one or more memories. For example, in some embodiments, the system and methods described herein may be implemented using one or more generative diffusion models, one or more generative language models (e.g., as described in FIGS. 4A-4C), one or more computing devices or components thereof (e.g., as described in FIG. 5), and/or one or more data centers or components thereof (e.g., as described in FIG. 6).

In at least one embodiment, computing system 100 may include any type of computing device, including, without limitation, a server machine, a server platform, a desktop machine, a laptop machine, a hand-held/mobile device, a digital kiosk, an in-vehicle infotainment system, a smart speaker or display, a television, and/or a wearable device. In at least one embodiment, computing system 100 is a server machine operating in a data center or a cloud computing environment that provides scalable computing resources as a service over a network.

In various embodiments, computing system 100 includes, without limitation, one or more processors 102 and one or more memories 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as (but not limited to) a keyboard, mouse, touch screen, sensor data analysis (e.g., evaluating gestures, speech, or other information about one or more uses in a field of view or sensory field of one or more sensors), a VR/MR/AR headset, a gesture recognition system, a steering wheel, mechanical, digital, or touch sensitive buttons or input components, and/or a microphone, and forward the input information to processor(s) 102 for processing. In at least one embodiment, computing system 100 may be a server machine in a cloud computing environment. In such embodiments, computing system 100 may omit input devices 108 and receive equivalent input information as commands (e.g., responsive to one or more inputs from a remote computing device) and/or messages transmitted over a network and received via the network adapter 118. In at least one embodiment, switch 116 is configured to provide connections between I/O bridge 107 and other components of computing system 100, such as a network adapter 118 and various add-in cards 120 and 121.

In at least one embodiment, I/O bridge 107 is coupled to a system disk 114 that may be configured to store content and applications and data for use by processor(s) 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid-state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computing system 100, may be implemented using any technically suitable protocols, including, without limitation, AGP (Accelerated Graphics Port), HyperTransport, or any other bus or point-to-point communication protocol known in the art.

In at least one embodiment, parallel processing subsystem 112 includes a graphics subsystem that delivers pixels to an optional display device 110 that may be any conventional cathode ray tube, liquid crystal display, light-emitting diode display, and/or the like. In such embodiments, parallel processing subsystem 112 may incorporate circuitry optimized for graphics and video processing, including, for example, video output circuitry. Such circuitry may be incorporated across one or more parallel processing units (PPUs), also referred to herein as parallel processors, included within the parallel processing subsystem 112.

In at least one embodiment, parallel processing subsystem 112 incorporates circuitry optimized (e.g., that undergoes optimization) for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and/or compute processing operations. Memor(ies) 104 include at least one device driver configured to manage the processing operations of the one or more PPUs within parallel processing subsystem 112. In addition, memor(ies) 104 include an adaptation engine 122, which can be executed by processor(s) and/or parallel processing subsystem 112.

In various embodiments, parallel processing subsystem 112 may be integrated with one or more of the other elements of FIG. 1 to form a single system. For example, parallel processing subsystem 112 may be integrated with processor(s) 102 and other connection circuitry on a single chip to form a system on a chip (SoC).

Processor(s) 102 may include any suitable processor implemented as a central processing unit (CPU), a graphics processing unit (GPU), an application-specific integrated circuit (ASIC), a field programmable gate array (FPGA), an artificial intelligence (AI) accelerator, a deep learning accelerator (DLA), a parallel processing unit (PPU), a data processing unit (DPU), a vector or vision processing unit (VPU), a programmable vision accelerator (PVA) (which may include one or more VPUs and/or direct memory access (DMA) systems), any other type of processing unit, or a combination of different processing units, such as a CPU(s) configured to operate in conjunction with a GPU(s). In general, processor(s) 102 may include any technically feasible hardware unit capable of processing data and/or executing software applications. Further, in the context of this disclosure, the computing elements shown in computing system 100 may correspond to a physical computing system (e.g., a system in a data center or a machine) and/or may correspond to a virtual computing instance executing within a computing cloud.

In at least one embodiment, processor(s) 102 issue commands that control the operation of PPUs. In at least one embodiment, communication path 113 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processors 102, and the number of parallel processing subsystems 112, may be modified as desired. For example, in at least one embodiment, memor(ies) 104 may be connected to processor(s) 102 directly rather than through memory bridge 105, and other devices may communicate with memor(ies) 104 via memory bridge 105 and processors 102. In other embodiments, parallel processing subsystem 112 may be connected to I/O bridge 107 or directly to processor(s) 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 may be eliminated, and network adapter 118 and add-in cards 120, 121 would connect directly to I/O bridge 107. Lastly, in certain embodiments, one or more components shown in FIG. 1 may be implemented as virtualized resources in a virtual computing environment, such as a cloud computing environment. In particular, the parallel processing subsystem 112 may be implemented as a virtualized parallel processing subsystem in at least one embodiment. For example, the parallel processing subsystem 112 may be implemented as a virtual graphics processing unit(s) (vGPU(s)) that renders graphics on a virtual machine(s) (VM(s)) executing on a server machine(s) whose GPU(s) and other physical resources are shared across one or more VMs.

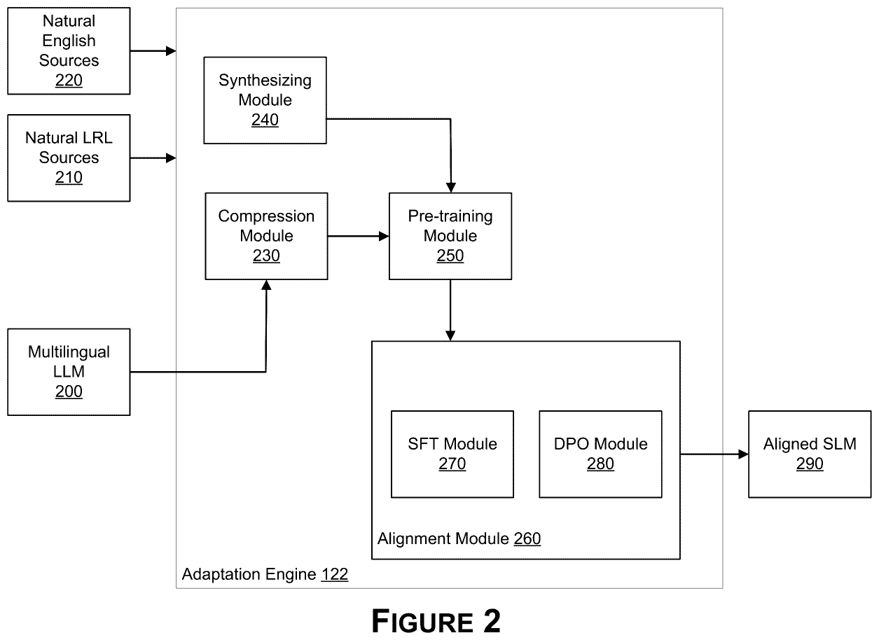

FIG. 2 is a more detailed illustration of adaptation engine 122 of FIG. 1, according to various embodiments. In at least one embodiment, adaptation engine 122 generates aligned Small Language Model (SLM) 290 based on multilingual Large Language Model (LLM) 200, natural Low-Resource Language (LRL) sources 210, and natural English sources 220. Adaptation engine 122 includes, without limitation, compression module 230, synthesizing module 240, pre-training module 250, and alignment module 260 comprising Supervised Fine-Tuning (SFT) module 270 and Direct Preference Optimization (DPO) module 280.

In at least one embodiment, Multilingual LLM 200 may include one or more generative language models, such as those described with respect to FIGS. 4A-4C. Multilingual LLM 200 may have been previously trained on one or more corpora that include training tokens expressed in multiple different languages. Multilingual LLM 200 may therefore exhibit varying degrees of capacity to understand, process, and generate natural language content expressed in any of the multiple different languages represented in the training corpora. In various embodiments, multilingual LLM 200 may include a relatively large number of learnable parameters, such as 8 B (8 billion) parameters, 12 B parameters, 15 B parameters, or a greater number of parameters.

In various embodiments, natural LRL sources 210 and natural English sources 220 each include one or more training corpora that include documents and/or other textual content expressed in a low-resource language (LRL) or in English, respectively. In the context of both LRL sources and English sources, a natural source includes textual content that has not been translated from any other language or dialect into its current language. In at least one embodiment, natural LRL sources 210 and natural English sources 220 may be consolidated into a single repository of natural language sources, where each source includes a designation of its associated language. In various embodiments, sources included in either or both of natural LRL sources 210 or natural English sources 220 may be retrieved from commercially available and/or open-source data sets, or may be retrieved from data located in a network environment, such as the internet. In all embodiments, sources included in either of natural LRL sources 210 or natural English sources 220, as well as any techniques used to collect the sources, are commercially friendly and respect all relevant privacy, data security, and intellectual property regulations and/or industry standards.

In at least one embodiment that includes compression module 230, compression module 230 receives multilingual LLM 200 and generates a multilingual Small Language Model (SLM). Compression module 230 may perform one or more pruning or distillation operations to reduce the number of parameters in multilingual LLM 200. For example, multilingual LLM 200 may include approximately 15B parameters, while the multilingual SLM generated by compression module 230 may include approximately 4 B parameters. In various embodiments, compression module 230 may re-train the generated multilingual SLM using a training dataset that includes a small fraction, e.g., less than three percent, of the training data (not shown) originally used to train multilingual LLM 200. In at least one embodiment, the training dataset may include natural LRL data and/or synthetic LRL data generated by translating English content to the LRL. The resulting trained multilingual SLM is operable to translate inputs that include English or other High-Resource Language (HRL) content into one or more non-English languages, such as the LRL. Compression module 230 transmits the generated trained multilingual SLM to pre-training module 250 discussed herein.

In at least one embodiment, synthesizing module 240 executes a machine translation technique on one or more English documents and/or items of textual content retrieved from natural English sources 220 to produce associated synthetic LRL sources. In varying embodiments, synthesizing module 240 may filter the synthetic LRL sources to identify noisy translations included in the synthetic LRL sources. In at least one embodiment, synthesizing module 240 may apply an n-gram language model to each of the synthetic LRL sources and generate a perplexity score associated with each of the synthetic LRL sources. Based on the generated perplexity scores, synthesizing module 240 may discard one or more of the synthetic LRL sources.

Synthesizing module 240 may retrieve one or more LRL documents and/or items of textual content from natural LRL sources 210 and transliterate each of the one or more LRL documents and/or items of textual content into a corresponding Roman script transliteration. Synthesizing module 240 may also transliterate each of the one more synthetic LRL sources generated via translation into corresponding Roman script transliterations.

Synthesizing module 240 may generate a continued pre-training dataset, including natural LRL sources retrieved from natural LRL sources 210, synthetic LRL sources generated via translation, Roman script transliterations of both natural and synthetic LRL sources, and natural English sources retrieved from natural English sources 220. In various embodiments, the pre-training dataset may include sufficient data to generate approximately 400 B tokens for continued pre-training of the multilingual SLM. In at least one embodiment, the generated tokens include an approximately equal number of English tokens and LRL tokens. For example, a generated pre-training dataset may include sufficient data to generate approximately 60 B synthetic LRL tokens, 40 B natural LRL tokens, 100 B Roman script tokens transliterated from the LRL, and 200 B natural English tokens. In various embodiments, synthesizing module may perform a fuzzy deduplication technique on the generated pre-training data set and remove one document included in a pair of documents exhibiting at least a threshold level of similarity. Synthesizing module 240 transmits the generated pre-training data set to pre-training module 250.

In at least one embodiment that includes pre-training module 250, pre-training module 250 performs continued pre-training on the multilingual SLM generated by compression module 230 to generate a bilingual (i.e., English and LRL) SLM. Pre-training module 250 may apply the generated pre-training data set as input to the SLM, and evaluate the output of the SLM based on a standard causal model objective. In various embodiments, the standard causal model objective may include evaluating the bilingual SLM's prediction of a next token given a sequence of previous tokens. In these embodiments, the continued pre-training is self-supervised, as the generated pre-training dataset does not include (or require) human-generated labels or other designations of ground truth. Instead, the ground truth is inherent in the pre-training data—for a sequence of tokens generated from the pre-training dataset, pre-training module 250 evaluates the SLM based on the SLM's capacity to correctly predict the value of a next token included in the sequence, given the ordered combination of preceding tokens included in the sequence.

In various embodiments, pre-training module 250 may sample from the pre-training data set in batches, and within each batch, pre-training module 250 may assign a greater training weight to natural data included in the pre-training dataset compared to synthetic data. Pre-training module may continue to pre-train the SLM by iteratively modifying one or more adjustable parameters included in the SLM. Pre-training module 250 may discontinue pre-training after a predetermined number of batches, after a predetermined duration of time has elapsed, and/or when a loss function associated with the standard causal model objective indicates a predetermined threshold level of accuracy and/or model capacity associated with the SLM.

As discussed herein, pre-training module 250 performs continued pre-training on a multilingual SLM and generates a bilingual SLM. The inclusion of English documents in the pre-training data set mitigates catastrophic forgetting of English capabilities in the SLM, and contributes to training stability. In embodiments that include transliterated LRL sources in the pre-training data set, the inclusion of the transliterated LRL sources may enhance the SLM's ability to understand and process hybrid language queries that include both English and LRL content. For example, a multilingual SLM may be subjected to continued pre-training using a pre-training data set that includes English content, Hindi content, and Hindi content that has been transliterated into Roman script. In this example, after the continued pre-training is concluded, the resulting bilingual SLM may exhibit significant model capacity to understand and process not only English and Hindi, but also the hybrid language variation “Hinglish,” which includes both English and Hindi vocabulary and/or grammar. After concluding the continued pre-training, pre-training module 250 transmits the pre-trained, bilingual SLM to alignment module 260.

In various embodiments, alignment module 260 fine-tunes the pre-trained bilingual SLM generated by pre-training module 250 to align the SLM's behavior and outputs with human values and expectations. In various embodiments, one or more alignment techniques may reduce the SLM's generation of foul, toxic, or otherwise objectionable language in its outputs, and avoid the inclusion of sensitive information, such as names, e-mails, addresses, or telephone numbers in generated output. Alignment techniques may also reduce bias in the SLM's generated output, such as gender and/or ethnicity biases. Alignment techniques may also train the SLM to generate more polite language, or language that otherwise resembles language that a human user might expect from a live conversation and/or prefer in a conversational language model interface.

In at least one embodiment in which alignment module 260 includes Supervised Fine-Tuning (SFT) module 270, SFT module 270 trains the bilingual SLM on an SFT corpus. The SFT corpus may be relatively smaller than the pre-training data set, and include labeled examples such as query-response pairs, where each pair includes an associated label that either positively or negatively characterizes the query-response pair. For example, a label may characterize a query-response pair as “good” or “bad,” or as “acceptable” or “unacceptable.” In various embodiments, the labels may further characterize a query response-pair based on one or more specific alignment objectives. For example, a label may characterize a query-response pair as “unbiased” or “biased,” or as having “no objectionable language” or “objectionable language.” In various embodiments, a particular query-response pair may include multiple associated labels. Alternatively or additionally, a single label may characterize multiple aspects of a query-response pair, such as “acceptable/unbiased/polite.”

In various embodiments, the SFT corpus may include approximately 200,000 labeled examples each directed to a particular task, such as benchmarks, open question and answer, closed question and answer, writing, math, or coding. Each example may be expressed in one of English or the LRL. In an instance where SFT training data is not available in sufficient quantities, various embodiments may include an SFT corpus comprising predominantly or exclusively English examples. Supervised fine-tuning using only English examples may nonetheless enhance the SLM's capacity for instruction-following in the LRL. In at least one embodiment, SFT module 270 may fine-tune the SLM for one epoch, with a global batch size and a learning rate in the range [5e-6, 9e-7], using cosine annealing.

In at least one embodiment in which alignment module 260 includes Direct Preference Optimization (DPO) module 280, DPO module 280 fine-tunes the SLM on a DPO corpus including multiple triplets. Each of the multiple triplets may include a prompt, a preferred response, and a rejected response. In one embodiment, the DPO corpus may include approximately 200,000 English triplets, and approximately 60,000 synthetic LRL triplets, where the LRL triplets are generated by translating a subset of the English triplets. DPO module 280 may also filter the synthetic LRL triplets by back-translating the synthetic triplets into English and discarding synthetic LRL triplets for which the back-translated English triplet fails to exhibit at least a predetermined threshold similarity to the original English triplet.

DPO module 280 may train a reward-based policy network included in the SLM to maximize a reward difference between the preferred and rejected responses included in a triplet. In various embodiments, DPO module 280 may fine-tune the SLM for one epoch with a global batch size of 512 and a learning rate in the range of [9e-6, 9e-7], using cosine annealing. After completing SFT and/or DPO alignment on the SLM, alignment module generates aligned SLM 290.

The discussions of SFT and DPO alignment techniques herein are not intended to be limiting. In various embodiments, alignment module 260 may perform different and/or additional alignment techniques, such as Reinforcement Learning with Human FeedBack (RLHF), Reinforcement Learning with Artificial Intelligence Feedback (RLAIF), or Contrastive Learning Framework for Human Alignment (CLHA). Selection of one or more alignment techniques may be informed by, e.g., the availability of pre-generated training data sets including LRL content, or constraints on human availability for annotating training data.

In various embodiments, aligned SLM 290 includes a bilingual (i.e., English and LRL) small language model. Aligned SLM 290 may exhibit a reduced multilingual model capacity compared to multilingual LLM 200, but may exhibit an enhanced model capacity for understanding, processing, and generating LRL content and/or hybrid English/LRL content. By including English training data in the pre-training, SFT, and DPO corpora, aligned SLM 290 maintains model capacity for understanding, processing, and generating English content.

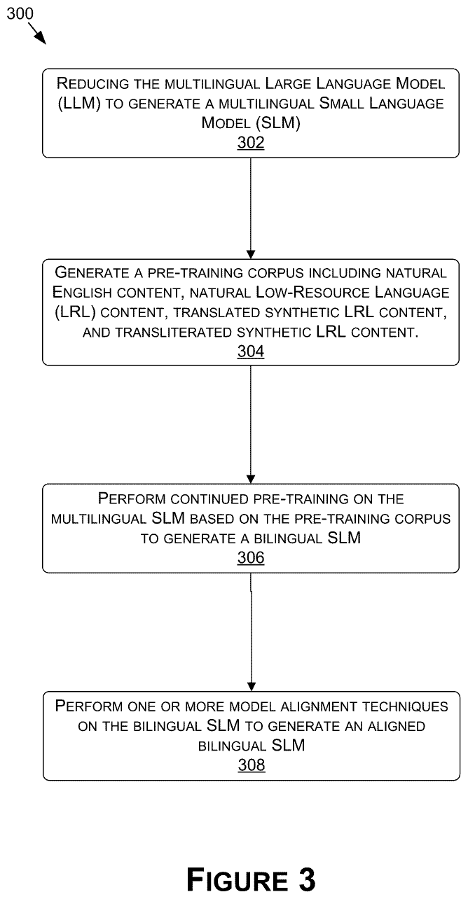

Now referring to FIG. 3, each block of method 300, described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, method 300 is described, by way of example, with respect to the system of FIG. 2. However, this method may additionally or alternatively be executed by any one system, or any combination of systems, including, but not limited to, those described herein.

FIG. 3 illustrates a flow diagram of a method 300 for generating an aligned bilingual Small Language Model (SLM), according to various embodiments of the present disclosure. The method 300, at block 302, includes reducing the number of parameters in multilingual Large Language Model (LLM) 200 via compression module 230 of adaptation engine 122. In various embodiments, compression module 230 may perform one or more pruning and/or distillation techniques to reduce the number of parameters from, e.g., 8 B, 12 B, or 15 B parameters included in multilingual LLM 200 to generate a multilingual SLM including, e.g., 4 B parameters. Compression module 230 may re-train the multilingual SLM on a small portion, such as 1-3%, of the training data used to generate multilingual LLM 200. Compression module 230 transmits the multilingual SLM to pre-training module 250.

At block 304, pre-training module 250 of adaptation engine 122 generates a pre-training corpus including natural English content, natural Low-Resource Language (LRL) content, translated synthetic LRL content, and transliterated synthetic LRL content. Pre-training module 250 generates the pre-training corpus based on content received from synthesizing module 240. In various embodiments, the pre-training corpus may include content sufficient to generate approximately 400 B training tokens. The content may be divided approximately evenly between English and the LRL, with the LRL content comprising approximately 80% synthetic LRL content and 20% natural LRL content.

At block 306, pre-training module 250 of adaptation engine 122 performs continued pre-training on the multilingual SLM based on the pre-training corpus to generate a bilingual SLM. The continued pre-training enhances the LRL model capacity of the SLM, based on the LRL content included in the pre-training corpus, while the English content included in the pre-training corpus preserves the SLM's model capacity in English and contributes to training stability. The inclusion of transliterated LRL content in the pre-training corpus enhances the SLM's model capacity to understand and process hybrid content that includes both English and LRL vocabulary and/or grammar. At the completion of pre-training, the SLM is now a bilingual SLM (i.e., English and LRL). Pre-training module 250 transmits the pre-trained SLM to alignment module 260.

At block 308, alignment module 260 of adaptation engine 122 performs one or more alignment techniques on the bilingual SLM to generate an aligned bilingual SLM. The one or more techniques align the SLM's behavior and outputs with human values and expectations. In various embodiments, one or more alignment techniques may reduce the SLM's generation of foul, toxic, or otherwise objectionable language in its outputs, and avoid the inclusion of sensitive information, such as names, e-mails, addresses, or telephone numbers in generated output. Alignment techniques may also reduce bias in the SLM's generated output, such as gender and/or ethnicity biases. Alignment techniques may also train the SLM to generate more polite language, or language that otherwise resembles language that a human user might expect from a live conversation and/or prefer in a conversational language model interface. In various embodiments, the alignment techniques may include one or more of Supervised Fine-Tuning (SFT), Direct Preference Optimization (DPO), Reinforcement Learning with Human FeedBack (RLHF), Reinforcement Learning with Artificial Intelligence Feedback (RLAIF), or Contrastive Learning Framework for Human Alignment (CLHA). Alignment module 260 generates aligned SLM 290 that includes a bilingual small language model. Aligned SLM 290 may exhibit a reduced multilingual model capacity compared to multilingual LLM 200, but may exhibit an enhanced model capacity for understanding, processing, and generating LRL content and/or hybrid English/LRL content. By including English training data in the pre-training, SFT, and DPO corpora, aligned SLM 290 maintains model capacity for understanding, processing, and generating English content.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems using or deploying one or more inference microservices, systems incorporating one or more machine learning models deployed in a service or microservice along with an OS-level virtualization package, systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models - such as one or more large language models (LLMs), one or more small language models (SLMs), one or more vision language models (VLMs), one or more multimodal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), small language models (SLMs), vision language models (VLMs), multimodal language models (MMLMs), and/or other types of generative artificial intelligence (AI) may be implemented to generate and/or process linguistic data. For example, one or more embodiments may include instances of multilingual LLM 200 and/or aligned SLM 290 that incorporate one or more language models. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs. VLMs/MMLMs/etc. of the present disclosure may be used exclusively for text processing, in embodiments, whereas in other embodiments, multimodal LLMs may be implemented to accept, understand, and/or generate text and/or other types of content like images, audio, 2D and/or 3D data (e.g., in USD formats), and/or video. For example, vision language models (VLMs), or more generally multimodal language models (MMLMs), may be implemented to accept image, video, audio, textual, 3D design (e.g., CAD), and/or other input data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs - such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures - such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to prevent a particular undesired input from being processed using the LLMs/SLMs/VLMs/MMLMs/etc., and/or to prevent the output or presentation (e.g., display, audio output, etc.) of undesired information generated using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation, based on one or more programmed or otherwise specified guardrails. As a result, the LLMs/SLMs/VLMs/MMLMs/etc. of the present disclosure may be less likely to output labels, captions, and/or textual descriptions that include language/text/audio/video/design data/USD data/etc. that may be offensive, vulgar, improper, unsafe, out of domain, and/or otherwise undesired for the particular application/implementation.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources - such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 4A is a block diagram of an example generative language model system 400 suitable for use in implementing at least some embodiments of the present disclosure. Some embodiments of the present disclosure may incorporate one or more implementations of generative language model system 400, as described in FIGS. 4A-4C, into, e.g., multilingual LLM 200 and/or aligned SLM 290. In the example illustrated in FIG. 4A, the generative language model system 400 includes a retrieval augmented generation (RAG) component 492, an input processor 405, a tokenizer 410, an embedding component 420, plug-ins/APIs 495, and a generative language model (LM) 430 (which may include an LLM, a SLM, a VLM, a multimodal LM, etc.).

At a high level, the input processor 405 may receive an input 401 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 430 (e.g., LLM/SLM/VLM/MMLM/etc.). In some embodiments, the input 401 includes plain text in the form of one or more sentences, paragraphs, and/or documents. Additionally or alternatively, the input 401 may include numerical sequences, precomputed embeddings (e.g., word or sentence embeddings), and/or structured data (e.g., in tabular formats, JSON, or XML). In some implementations in which the generative LM 430 is capable of processing multimodal inputs, the input 401 may combine text (or may omit text) with image data, audio data, video data, design data, USD data, and/or other types of input data, such as but not limited to those described herein. Taking raw input text as an example, the input processor 405 may prepare raw input text in various ways. For example, the input processor 405 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 405 may remove stopwords to reduce noise and focus the generative LM 430 on more meaningful content. The input processor 405 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 492 (which may include one or more RAG models, and/or may be performed using LM 430 itself) may be used to retrieve additional information to be used as part of the input 401 or prompt. RAG may be used to enhance the input to the LLM/SLM/VLM/MMLM/etc. with external knowledge, so that answers to specific questions or queries or requests are more relevant—such as in a case where specific knowledge is required. The RAG component 492 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 401 may be generated using the query or input to the model (e.g., a question, a request, etc.) in addition to data retrieved using the RAG component 492. In some embodiments, the input processor 405 may analyze the input 401 and communicate with the RAG component 492 (or the RAG component 492 may be part of the input processor 405, in embodiments) in order to identify relevant text and/or other data to provide to the generative LM 430 as additional context or sources of information from which to identify the response, answer, or output 490, generally. For example, where the input indicates that the user is interested in a desired tire pressure for a particular make and model of vehicle, the RAG component 492 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 492 may retrieve a prior stored conversation history—or at least a summary thereof—and include the prior conversation history along with the current ask/request as part of the input 401 to the generative LM 430.

The RAG component 492 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 492 and the embeddings of the chunks along with the embeddings of the query may be compared to identify the most similar/related embeddings to the query, which may be supplied to the generative LM 430 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 492 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 410 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 430 to understand morphological variations and handle out-of-vocabulary words more effectively. Character-based tokenization represents each character as a separate token, enabling the generative LM 430 to process text at a fine-grained level. The choice of tokenization strategy may depend on factors such as the language being processed, the task at hand, and/or characteristics of the training dataset. As such, the tokenizer 410 may convert the (e.g., processed) text into a structured format according to tokenization schema being implemented in the particular embodiment.

The embedding component 420 may use any known embedding technique to transform discrete tokens into (e.g., dense, continuous vector) representations of semantic meaning. For example, the embedding component 420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data/video data/etc., the input processor 405 may resize the data to a standard size compatible with format of a corresponding input channel and/or may normalize pixel values to a common range (e.g., 0 to 1) to ensure a consistent representation, and the embedding component 420 may encode the image data using any known technique (e.g., using one or more convolutional neural networks (CNNs) to extract visual features). In some implementations in which the input 401 includes audio data, the input processor 405 may resample an audio file to a consistent sampling rate for uniform processing, and the embedding component 420 may use any known technique to extract and encode audio features—such as in the form of a spectrogram (e.g., a mel-spectrogram). In some implementations in which the input 401 includes video data, the input processor 405 may extract frames or apply resizing to extracted frames, and the embedding component 420 may extract features such as optical flow embeddings or video embeddings and/or may encode temporal information or sequences of frames. In some implementations in which the input 401 includes multimodal data, the embedding component 420 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 430 and/or other components of the generative LM system 400 may use different types of neural network architecture depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 may apply an encoded representation of the input 401 to the generative LM 430, and the generative LM 430 may process the encoded representation of the input 401 to generate an output 490, which may include responsive text and/or other types of data.

As described herein, in some embodiments, the generative LM 430 may be configured to access or use—or capable of accessing or using—plug-ins/APIs 495 (which may include one or more plug-ins, application programming interfaces (APIs), databases, data stores, repositories, etc.). For example, for certain tasks or operations that the generative LM 430 is not ideally suited for, the model may have instructions (e.g., as a result of training, and/or based on instructions in a given prompt, such as those retrieved using the RAG component 492) to access one or more plug-ins/APIs 495 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 495 to the plug-in/API 495, the plug-in/API 495 may process the information and return an answer to the generative LM 430, and the generative LM 430 may use the response to generate the output 490. This process may be repeated—e.g., recursively—for any number of iterations and using any number of plug-ins/APIs 495 until an output 490 that addresses each ask/question/request/process/operation/etc. from the input 401 can be generated. As such, the model(s) may not only rely on its own knowledge from training on a large dataset(s) and/or from data retrieved using the RAG component 492, but also on the expertise or optimized nature of one or more external resources - such as the plug-ins/APIs 495.

FIG. 4B is a block diagram of an example implementation in which the generative LM 430 includes a transformer encoder-decoder. For example, assume input text such as “Who discovered gravity” is tokenized (e.g., by the tokenizer 410 of FIG. 4A) into tokens such as words, and each token is encoded (e.g., by the embedding component 420 of FIG. 94A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 435 of the generative LM 430.

In an example implementation, the encoder(s) 435 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 440 may convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 may generate a first token, and the generation mechanism 455 may apply the generated token as an input during a second pass. The process may repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 may output some decoded (e.g., vector) representation of the input being applied during a particular pass. The classifier 450 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 may select or sample a word or token based on a corresponding predicted probability (e.g., select the word with the highest predicted probability) and append it to the output from a previous pass, generating each word or token sequentially. The generation mechanism 455 may repeat the process, triggering successive decoder inputs and corresponding predictions until selecting or sampling a symbol or token that represents the end of the response, at which point, the generation mechanism 455 may output the generated response.

FIG. 4C is a block diagram of an example implementation in which the generative LM 430 includes a decoder-only transformer architecture. For example, the decoder(s) 460 of FIG. 4C may operate similarly as the decoder(s) 445 of FIG. 4B except each of the decoder(s) 460 of FIG. 4C omits the encoder-decoder self-attention layer (since there is no encoder in this implementation). As such, the decoder(s) 460 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 460. As with the decoder(s) 445 of FIG. 4B, each token (e.g., word) may flow through a separate path in the decoder(s) 460, and the decoder(s) 460, a classifier 465, and a generation mechanism 470 may use auto-regression to sequentially generate one token at a time until predicting a symbol or token that represents the end of the response. The classifier 465 and the generation mechanism 470 may operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, including wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that may be used in at least one embodiment of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may use distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network-attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.
1. In some embodiments, one or more processors comprising processing circuitry to translate one or more data sources included in a set of natural English data sources into a Low-Resource Language (LRL) to generate a set of synthetic LRL data sources, transliterate at least a subset of the set of synthetic LRL data sources and one or more data sources included in a set of natural LRL data sources into a Roman script to generate a set of transliterated LRL data sources, and perform continued pre-training on a trained multilingual Small Language Model (SLM) using data sources included in one or more of the set of natural English data sources, the set of natural LRL data sources, the set of synthetic LRL data sources, or the set of transliterated LRL data sources to generate a bilingual Small Language Model (SLM).
2. The one or more processors of clause 1, wherein the one or more processors are comprised in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing remote operations, a system for performing real-time streaming, a system for generating or presenting one or more of augmented reality content, virtual reality content, or mixed reality content, a system implemented using an edge device, a system implemented using a robot, a system for performing conversational AI operations, a system implementing one or more multimodal language models, a system implementing one or more large language models (LLMs), a system implementing one or more small language models (SLMs), a system implementing one or more vision language models (VLMs), a system for generating synthetic data, a system for generating synthetic data using AI, a system incorporating one or more virtual machines (VMs), a system using or deploying one or more inference microservices, a system incorporating one or more machine learning models deployed in a service or microservice along with an OS-level virtualization package, a system implemented at least partially in a data center, or a system implemented at least partially using cloud computing resources.
3. The one or more processors of clauses 1 or 2, wherein the one or more processors further comprise processing circuitry to apply one or more compression techniques to a trained multilingual Large Language Model (LLM) to generate the trained multilingual SLM.
4. The one or more processors of any of clauses 1-3, wherein the one or more processors further comprise processing circuitry to re-train the trained multilingual SLM based at least on a portion of training data upon which the trained multilingual LLM was previously trained.
5. The one or more processors of any of clauses 1-4, wherein the one or more processors further comprise processing circuitry to perform one or more alignment techniques on the bilingual SLM to generate an aligned SLM, wherein the alignment techniques include one or more of a Supervised Fine-Tuning (SFT) technique or a Direct Preference Optimization (DPO) technique.
6. The one or more processors of any of clauses 1-5, wherein the one or more processors further comprise processing circuitry to remove one or more synthetic LRL data sources from the set of synthetic LRL data sources, based at least on perplexity scores associated with one or more synthetic LRL data sources included in the set of synthetic LRL data sources.
7. The one or more processors of any of clauses 1-6, wherein the one or more processors further comprise processing circuitry to remove a synthetic LRL data source from the set of synthetic LRL data sources, based at least on a comparison of a back-translation of the synthetic LRL data source into English and a natural English data source associated with the synthetic LRL data source.
8. The one or more processors of any of clauses 1-7, wherein the bilingual SLM is operable to understand and process a query that includes both English and LRL textual content.
9. The one or more processors of any of clauses 1-8, wherein the one or more processors further comprise processing circuitry to identify a pair of documents exhibiting at least a threshold level of similarity, and remove one document of the pair of documents.
10. The one or more processors of any of clauses 1-9, wherein the continued pre-training further comprises assigning a first weight to each natural LRL data source included in the set of natural LRL data sources and assigning a second weight to each synthetic LRL data source included in the set of synthetic LRL data sources, wherein the first weight is numerically greater than the second weight.
11. In some embodiments, a system comprises one or more processors to translate one or more data sources included in a set of natural English data sources into a Low-Resource Language (LRL) to generate a set of synthetic LRL data sources, transliterate at least a subset of the set of synthetic LRL data sources and one or more data sources included in a set of natural LRL data sources to generate a set of transliterated LRL data sources, and perform continued pre-training on a trained multilingual Small Language Model (SLM) using data sources included in one or more of the set of natural English data sources, the set of natural LRL data sources, the set of synthetic LRL data sources, or the set of transliterated LRL data sources to generate a bilingual Small Language Model (SLM).
12. The system of clause 11, wherein the system is comprised in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing remote operations, a system for performing real-time streaming, a system for generating or presenting one or more of augmented reality content, virtual reality content, or mixed reality content, a system implemented using an edge device, a system implemented using a robot, a system for performing conversational AI operations, a system implementing one or more multimodal language models, a system implementing one or more large language models (LLMs), a system implementing one or more small language models (SLMs), a system implementing one or more vision language models (VLMs), a system for generating synthetic data, a system for generating synthetic data using AI, a system incorporating one or more virtual machines (VMs), a system using or deploying one or more inference microservices, a system incorporating one or more machine learning models deployed in a service or microservice along with an OS-level virtualization package, a system implemented at least partially in a data center, or a system implemented at least partially using cloud computing resources.
13. The system of clauses 11 or 12, wherein the one or more processors are further comprised to apply one or more compression techniques to a trained multilingual Large Language Model (LLM) to generate the trained multilingual SLM.
14. The system of any of clauses 11-13, wherein the one or more processors are further comprised to re-train the multilingual SLM based at least on a portion of training data upon which the multilingual LLM was previously trained.
15. The system of any of clauses 11-14, wherein the one or more processors are further comprised to perform one or more alignment techniques on the bilingual SLM to generate an aligned SLM, wherein the alignment techniques include one or more of a Supervised Fine-Tuning (SFT) technique or a Direct Preference Optimization (DPO) technique.
16. The system of any of clauses 11-15, wherein the one or more processors are further comprised to remove one or more synthetic LRL data sources from the set of synthetic LRL data sources, based at least on perplexity scores associated with one or more of the synthetic LRL data sources included in the set of synthetic LRL data sources.
17. The system of any of clauses 11-16, wherein the one or more processors are further comprised to remove a synthetic LRL data source from the set of synthetic LRL data sources, based at least on a comparison of a back-translation of the synthetic LRL data source into English and a natural English data source associated with the synthetic LRL data source.
18. the System of Any of Clauses 11-17,

wherein the continued pre-training further comprises assigning a first weight to each data source included in the set of natural LRL data sources and assigning a second weight to each data source included in the set of synthetic LRL data sources, wherein the first weight is numerically greater than the second weight.
19. In some embodiments, a method comprises translating, using a trained multilingual small language model, an input from a first language into a second, non-English language, wherein the trained multilingual small language model is generated at least by (i) compressing a multilingual large language model to generate an initial multilingual small language model, and (ii) training the initial multilingual small language model using a training dataset to generate the trained multilingual small language model, the training dataset including at least natural Low-Resource Language (LRL) data and synthetic LRL data generated at least by translating High-Resource Language (HRL) data to the LRL.
20. The method of clause 19, wherein the method is performed by at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing remote operations, a system for performing real-time streaming, a system for generating or presenting one or more of augmented reality content, virtual reality content, or mixed reality content, a system implemented using an edge device, a system implemented using a robot, a system for performing conversational AI operations, a system implementing one or more multimodal language models, a system implementing one or more large language models (LLMs), a system implementing one or more small language models (SLMs), a system implementing one or more vision language models (VLMs), a system for generating synthetic data, a system for generating synthetic data using AI, a system incorporating one or more virtual machines (VMs), a system using or deploying one or more inference microservices, a system incorporating one or more machine learning models deployed in a service or microservice along with an OS-level virtualization package, a system implemented at least partially in a data center, or a system implemented at least partially using cloud computing resources.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
translate one or more data sources included in a set of natural English data sources into a Low-Resource Language (LRL) to generate a set of synthetic LRL data sources;
transliterate at least a subset of the set of synthetic LRL data sources and one or more data sources included in a set of natural LRL data sources into a Roman script to generate a set of transliterated LRL data sources; and
perform continued pre-training on a trained multilingual Small Language Model (SLM) using data sources included in one or more of the set of natural English data sources, the set of natural LRL data sources, the set of synthetic LRL data sources, or the set of transliterated LRL data sources to generate a bilingual Small Language Model (SLM).

2. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multimodal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system incorporating one or more machine learning models deployed in
a service or microservice along with an OS-level virtualization package;
a system implemented at least partially in a data center; or
a system implemented at least partially using cloud computing resources.

3. The one or more processors of claim 1, wherein the one or more processors further comprise processing circuitry to apply one or more compression techniques to a trained multilingual Large Language Model (LLM) to generate the trained multilingual SLM.

4. The one or more processors of claim 3, wherein the one or more processors further comprise processing circuitry to re-train the trained multilingual SLM based at least on a portion of training data upon which the trained multilingual LLM was previously trained.

5. The one or more processors of claim 1, wherein the one or more processors further comprise processing circuitry to perform one or more alignment techniques on the bilingual SLM to generate an aligned SLM, wherein the alignment techniques include one or more of a Supervised Fine-Tuning (SFT) technique or a Direct Preference Optimization (DPO) technique.

6. The one or more processors of claim 1, wherein the one or more processors further comprise processing circuitry to remove one or more synthetic LRL data sources from the set of synthetic LRL data sources, based at least on perplexity scores associated with one or more synthetic LRL data sources included in the set of synthetic LRL data sources.

7. The one or more processors of claim 1, wherein the one or more processors further comprise processing circuitry to remove a synthetic LRL data source from the set of synthetic LRL data sources, based at least on a comparison of a back-translation of the synthetic LRL data source into English and a natural English data source associated with the synthetic LRL data source.

8. The one or more processors of claim 1, wherein the bilingual SLM is operable to understand and process a query that includes both English and LRL textual content.

9. The one or more processors of claim 1, wherein the one or more processors further comprise processing circuitry to identify a pair of documents exhibiting at least a threshold level of similarity, and remove one document of the pair of documents.

10. The one or more processors of claim 1, wherein the continued pre-training further comprises assigning a first weight to each natural LRL data source included in the set of natural LRL data sources and assigning a second weight to each synthetic LRL data source included in the set of synthetic LRL data sources, wherein the first weight is numerically greater than the second weight.

11. A system comprising one or more processors to:
translate one or more data sources included in a set of natural English data sources into a Low-Resource Language (LRL) to generate a set of synthetic LRL data sources;
transliterate at least a subset of the set of synthetic LRL data sources and one or more data sources included in a set of natural LRL data sources to generate a set of transliterated LRL data sources; and
perform continued pre-training on a trained multilingual Small Language Model (SLM) using data sources included in one or more of the set of natural English data sources, the set of natural LRL data sources, the set of synthetic LRL data sources, or the set of transliterated LRL data sources to generate a bilingual Small Language Model (SLM).

12. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multimodal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system incorporating one or more machine learning models deployed in a service or microservice along with an OS-level virtualization package;
a system implemented at least partially in a data center; or a system implemented at least partially using cloud computing resources.

13. The system of claim 11, wherein the one or more processors are further comprised to apply one or more compression techniques to a trained multilingual Large Language Model (LLM) to generate the trained multilingual SLM.

14. The system of claim 13, wherein the one or more processors are further comprised to re-train the multilingual SLM based at least on a portion of training data upon which the multilingual LLM was previously trained.

15. The system of claim 11, wherein the one or more processors are further comprised to perform one or more alignment techniques on the bilingual SLM to generate an aligned SLM, wherein the alignment techniques include one or more of a Supervised Fine-Tuning (SFT) technique or a Direct Preference Optimization (DPO) technique.

16. The system of claim 11, wherein the one or more processors are further comprised to remove one or more synthetic LRL data sources from the set of synthetic LRL data sources, based at least on perplexity scores associated with one or more of the synthetic LRL data sources included in the set of synthetic LRL data sources.

17. The system of claim 11, wherein the one or more processors are further comprised to remove a synthetic LRL data source from the set of synthetic LRL data sources, based at least on a comparison of a back-translation of the synthetic LRL data source into English and a natural English data source associated with the synthetic LRL data source.

18. The system of claim 11, wherein the continued pre-training further comprises assigning a first weight to each data source included in the set of natural LRL data sources and assigning a second weight to each data source included in the set of synthetic LRL data sources, wherein the first weight is numerically greater than the second weight.

19. A method comprising:
translating, using a trained multilingual small language model, an input from a first language into a second, non-English language, wherein the trained multilingual small language model is generated at least by: (i) compressing a multilingual large language model to generate an initial multilingual small language model; and (ii) training the initial multilingual small language model using a training dataset to generate the trained multilingual small language model, the training dataset including at least natural Low-Resource Language (LRL) data and synthetic LRL data generated at least by translating High-Resource Language (HRL) data to the LRL.

20. The method of claim 19, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multimodal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system incorporating one or more machine learning models deployed in a service or microservice along with an OS-level virtualization package;
a system implemented at least partially in a data center; or
a system implemented at least partially using cloud computing resources.
